(19) United States
(12) Patent Application Publication
(10) Pub. No.: US 2026/0074356 A1
(43) Pub. Date: Mar. 12, 2026

(54) CAP ASSEMBLY, SECONDARY BATTERY INCLUDING CAP ASSEMBLY, AND METHOD OF MANUFACTURING CAP ASSEMBLY

(71) Applicant: SAMSUNG SDI CO., LTD., Yongin-si (KR)

(72) Inventor: Jiwon YUN, Yongin-si (KR)

(21) Appl. No.: 19/256,717

(22) Filed: Jul. 1, 2025

(30) Foreign Application Priority Data
Sep. 12, 2024 (KR) 10-2024-0124414

(51) Int. Cl. H01M 50/342; H01M 50/152

(52) U.S. Cl. CPC H01M 50/3425; H01M 50/152

(57) ABSTRACT

A cap assembly may include a upper cap, a vent plate disposed below the upper cap, with the vent plate being deformable and including a vent protruding downward A lower cap is disposed below the vent plate, with a through hole being formed in the lower cap, and with the vent inserted into the through hole. A sub-plate is disposed below the lower cap and joined to the vent and the lower cap to electrically connect the vent plate and the lower cap. An insulator is disposed between the vent plate and the lower cap. At least a portion of a surface of the lower cap is in contact with the insulator may be surface treated to have a greater roughness than another surface of the lower cap.

### CROSS-REFERENCE TO RELATED APPLICATION

The present application claims priority to and the benefit of Korean Application No. 10-2024-0124414, filed on Sep. 12, 2024, in the Korean Intellectual Property Office, the entire disclosure of which is incorporated by reference herein.

### BACKGROUND

### Field

Aspects of embodiments of the present disclosure relate to a cap assembly, a secondary battery including the cap assembly, and a method of manufacturing the cap assembly.

### Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In cylindrical secondary batteries, a current interrupt device (CID) is provided to ensure safety. The CID is a protective device that can prevent an explosion of a secondary battery by interrupting a current flow in the electrode assembly and the cap assembly when the internal pressure of the secondary battery increases.

An insulator that constitutes the CID insulates between the electrode assembly and the cap assembly in the event of a battery short circuit. However, a problem may occur in which the insulator falls off during a process in which a vent plate is deformed due to an increase in internal pressure in the secondary battery, thereby preventing a current flow from being blocked.

The above information disclosed in this Background section is for enhancement of understanding of the background of the present disclosure, and therefore, it may contain information that does not constitute related (or prior) art.

### SUMMARY

Aspects of embodiments of the present disclosure provide a cap assembly, a secondary battery including the cap assembly, and a method of manufacturing the cap assembly.

These and other aspects and features of the present disclosure will be described in or will be apparent from the following description of embodiments of the present disclosure.

According to one or more embodiments of the present disclosure, a cap assembly may include an upper cap, a vent plate disposed below the upper cap, with the upper cap being deformable and including a vent protruding downward, a lower cap disposed below the vent plate, with a through hole being formed in the lower cap, and with the vent being inserted into the through hole, a sub-plate disposed below the lower cap and joined to the vent and the lower cap to electrically connect the vent plate and the lower cap, and an insulator disposed between the vent plate and the lower cap, at least a portion of a surface of the lower cap in contact with the insulator may be surface treated to have a greater roughness than another surface of the lower cap.

In some embodiments, the lower cap may include a lower plate having the through hole formed at a center thereof, a bridge portion protruding axially from an outer circumferential surface of the lower plate, an upper plate extending radially outward from an end of the bridge portion, and a pressing protrusion protruding radially inward, with an inner circumferential surface of the pressing portion contacting the insulator and including the portion of the lower cap that is surface treated to have a greater roughness.

In some embodiments, the inner circumferential surface of the pressing protrusion may include knurled grooves to provide the greater roughness.

In some embodiments, the inner circumferential surface of the pressing protrusion may include a plurality of grooves to provide the greater roughness.

In some embodiments, the inner circumferential surface of the pressing protrusion may include knurled grooves and a further plurality of grooves formed to provide the greater roughness.

In some embodiments, the insulator may include a ring-shaped plate disposed above the lower plate, a connecting portion configured to protrude axially from an outer circumferential surface of the ring plate, the connecting portion having a greater roughness than another surface of the insulator, and the connecting portion being in contact with the inner circumferential surface of the pressing protrusion, and a flange portion extending radially outward from an end of the connecting portion and disposed above the upper plate.

In some embodiments, the outer circumferential surface of the connecting portion may include knurled grooves to provide the greater roughness.

In some embodiments, the outer circumferential surface of the connecting portion may include a plurality of grooves to provide the greater roughness.

In some embodiments, the outer circumferential surface of the connecting portion may include knurled grooves and a further plurality of grooves plurality of grooves to provide the greater roughness.

According to one or more embodiments of the present disclosure, a secondary battery may include a case having an opening formed therein, an electrode assembly accommodated in the case, the electrode assembly comprising a first electrode, a separator, and a second electrode, and a cap assembly sealing the opening of the case, the cap assembly may include a upper cap, a vent plate disposed below the upper cap, the vent plate being deformable in response to pressure change inside the case, the vent plate comprising a vent protruding downward, a lower cap disposed below the vent plate, with a through hole being formed in the lower cap, and with the vent may be inserted into the through hole, a sub-plate disposed below the lower cap and joined to the vent and the lower cap to electrically connect the vent plate and the lower cap, and an insulator disposed between the vent plate and the lower cap, at least a portion of a surface of the lower cap in contact with the insulator may be surface treated to have a greater roughness than another surface of the lower cap.

According to one or more embodiments of the present disclosure, a method of manufacturing a cap assembly may include surface treating at least a portion of a surface of a lower cap that is configured to contact the insulator such that the portion of the surface may have a greater roughness than another surface of the lower cap, disposing the insulator above the lower cap, disposing a vent plate above the insulator so that a vent of a vent plate may be inserted into a through hole formed in lower cap, connecting a sub-plate to a lower portion of the lower cap and the vent so that the lower cap and the vent may be electrically connected by the sub-plate, and disposing a upper cap above the vent plate and joining the upper cap and the vent plate.

In some embodiments, the lower cap may include a lower plate having the through hole formed at a center thereof, a bridge portion protruding axially from an outer circumferential surface of the lower plate, an upper plate extending radially outward from an end of the bridge portion, and a pressing protrusion protruding radially inwardly from the upper plate, the surface treatment may include surface treating the pressing protrusion so that roughness of an inner circumferential surface of the pressing protrusion that is configured to contact the insulator may be greater than roughness of another surface of the lower cap.

In some embodiments, the surface treatment may include forming knurled grooves by knurling the inner circumferential surface of the pressing protrusion.

In some embodiments, the surface treatment may include forming a plurality of grooves by blasting the inner circumferential surface of the pressing protrusion.

In some embodiments, the surface treatment may include forming knurled grooves by knurling the inner circumferential surface of the pressing protrusion, and additionally forming a plurality of grooves by blasting the inner circumferential surface of the pressing protrusion on which the knurled grooves may be formed.

In some embodiments, the method may further include surface treating an outer circumferential surface of the insulator that is configured to contact the lower cap so that at least a portion of the surface of the insulator may have a greater roughness than another surface of the insulator.

In some embodiments, the outer circumferential surface of the insulator is configured to contact the inner circumferential surface of the pressing protrusion of the lower cap.

In some embodiments, the surface treating of the outer circumferential surface of the insulator may include forming knurled grooves by knurling the outer circumferential surface of the insulator.

In some embodiments, the surface treating of the outer circumferential surface of the insulator may include forming a plurality of grooves by blasting the outer circumferential surface of the insulator.

In some embodiments, the surface-treating of the outer circumferential surface of the insulator may include forming knurled grooves by knurling the outer circumferential surface of the insulator, and additionally forming a plurality of grooves by blasting the outer circumferential surface on which the knurled grooves may be formed.

According to some embodiments of the present disclosure, in the cap assembly of the secondary battery, the surface where the lower cap and the insulator come into contact with each other may be surface treated to improve the fastening strength of the insulator.

According to some embodiments of the present disclosure, in the cap assembly of the secondary battery, the roughness of the surface where the lower cap and the insulator come into contact with each other may be increased to improve the fastening strength through increased frictional force.

However, aspects and features of the present disclosure are not limited to those described above, and other aspects and features not mentioned will be clearly understood by a person skilled in the art from the detailed description, described below.

### BRIEF DESCRIPTION OF DRAWINGS

The drawings attached to this specification illustrate embodiments of the present disclosure, and further describe aspects and features of the present disclosure together with the detailed description of the present disclosure. The present disclosure should not be construed as being limited to the drawings:

FIG. 1 is a perspective view showing an example of a secondary battery according to some embodiments of the present disclosure.

FIG. 2 is an exploded perspective view showing an example of the cap assembly according to some embodiments of the present disclosure.

FIG. 3 is a cross-sectional view showing an example of the cap assembly according to some embodiments of the present disclosure.

FIG. 4 is an enlarged view showing an example of a region A of FIG. 3.

FIG. 5 is a perspective view showing an example of the lower cap in the cap assembly according to some embodiments of the present disclosure.

FIGS. 6 to 8 are enlarged views showing examples of the surface-treated inner circumferential surface of the pressing protrusion cut along a region B-B of FIG. 5.

FIG. 9 is a perspective view showing an example of the insulator in the cap assembly according to some embodiments of the present disclosure.

FIGS. 10 to 12 are enlarged views showing an example of the surface-treated outer circumferential surface of the insulator cut along a region C-C of FIG. 9.

FIG. 13 is a flowchart showing an example of a method of manufacturing a cap assembly according to some embodiments of the present disclosure.

FIGS. 14 to 16 illustrate examples of surface treatment of an inner circumferential surface of a pressing protrusion.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

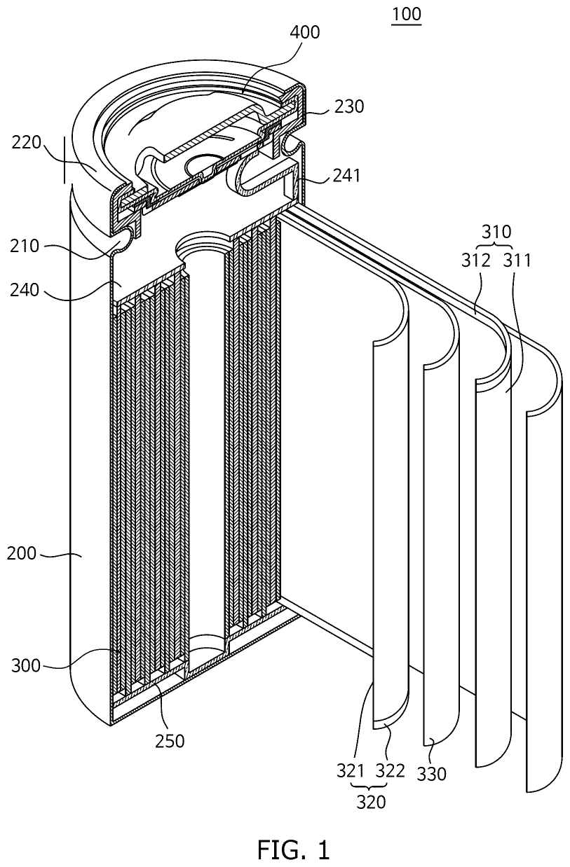

FIG. 1 is a perspective view showing an example of a secondary battery according to some embodiments of the present disclosure.

Referring to FIG. 1, a secondary battery 100 according to some embodiments of the present disclosure may include an electrode assembly 300, a case 200 having an opening and accommodating the electrode assembly 300, and a cap assembly 400 sealing the opening of the case 200.

The electrode assembly 300 may include a separator 330 and a first electrode 310 and a second electrode 320 positioned with the separator 330 interposed therebetween and may be wound in a jelly-roll shape.

The first electrode 310 includes a first substrate and a first active material layer 311 on the first substrate. The first electrode 310 includes a first uncoated portion 312 of the first substrate where the first active material layer 311 is not located. The second electrode 320 includes a second substrate and a second active material layer 321 on the second substrate. The second electrode 320 includes a second uncoated portion 322 of the second substrate where the second active material layer 321 is not located. The first uncoated portion 312 and the second uncoated portion 322 may extend in opposite directions.

The first electrode 310 may act as a positive electrode. In such some embodiments, the first substrate may be made of, for example, an aluminum foil, and the first active material layer 311 may include, for example, a transition metal oxide. The second electrode 320 may act as a negative electrode. In such embodiments, the second substrate may be made of, for example, a copper foil or a nickel foil, and the second active material layer 321 may include graphite, for example.

The separator 330 prevents a short circuit between the first electrode 310 and the second electrode 320 while allowing movement of lithium ions therebetween. The separator 330 may be made of, for example, a polyethylene film, a polypropylene film, a polyethylene-polypropylene film, or the like.

The case 200 may accommodate the electrode assembly 300 and an electrolyte, and the case may define the external appearance of the secondary battery 100 together with the cap assembly 400. The case 200 may be made of metal, such as aluminum, an aluminum alloy, nickel-plated steel, or stainless steel.

A first current collector plate 240 and a second current collector plate 250 electrically connected to the electrode assembly 300 may be provided inside the case 200. The first current collector plate 240 may be in contact and electrically connected to a first uncoated portion 312 of the first electrode 310. The second current collector plate 250 may be in contact and electrically connected to a second uncoated portion 322 of the second electrode 320.

In some embodiments, the first current collector plate 240 may be electrically connected to the cap assembly 400 through a connecting member 241. Therefore, the cap assembly 400 may function as the same electrode as the first electrode 310. The second current collector plate 250 may be welded to the bottom surface of the case 200 so that the case 200 may function as the same electrode as the second electrode 320.

The cap assembly 400 may seal the opening of the case 200. In particular, the cap assembly 400 may seal the case 200 while the electrode assembly 300 and the electrolyte are accommodated in the case 200. A gasket 230 may be provided between the cap assembly 400 and the case 200 to provide electrical insulation between the cap assembly 400 and the case 200.

In some embodiments, the gasket 230 and the cap assembly 400 may be disposed in a beading portion 210 that is recessed inward along the circumference of the case 200 adjacent to the opening of the case 200. A clamping portion 220 may be formed to bend the opened end of the case 200 toward the inside of the case 200, thereby joining the gasket 230 and the cap assembly 400 to the case 200. With this configuration, the cap assembly 400 may be disposed and press-fitted between the beading portion 210 and the clamping portion 220. The gasket 230 may be provided between the beading portion 210, the clamping portion 220, and the cap assembly 400 to thereby provide electrical insulation between the case 200 and the cap assembly 400.

The cap assembly 400 may include a upper cap, a vent plate disposed below the upper cap and deformable in response to pressure change, a lower cap disposed below the vent plate, and an insulator disposed between the vent plate and the lower cap. The lower cap and the vent plate may be electrically connected to each other. Also, the lower cap, the vent plate, and the insulator may form a CID. At least a portion of the surface of the lower cap in contact with the insulator may be surface treated to form a roughness greater than that of the other surfaces of the battery structure. Accordingly, in the cap assembly 400, the roughness of the surface of the lower cap that contacts the insulator may be increased to thereby increase that frictional force and thereby provide for greater fastening strength. Thus, it is possible to prevent a problem wherein the insulator falls off and current flow is not blocked when the vent plate constituting the CID is deformed due to an increase in internal pressure of the secondary battery.

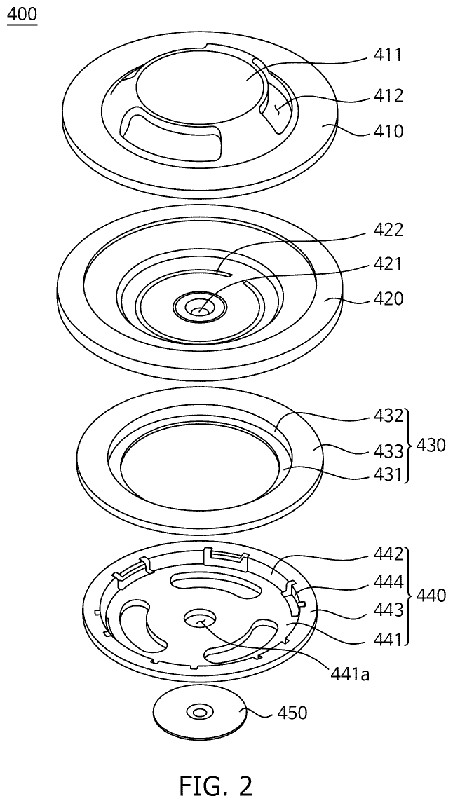

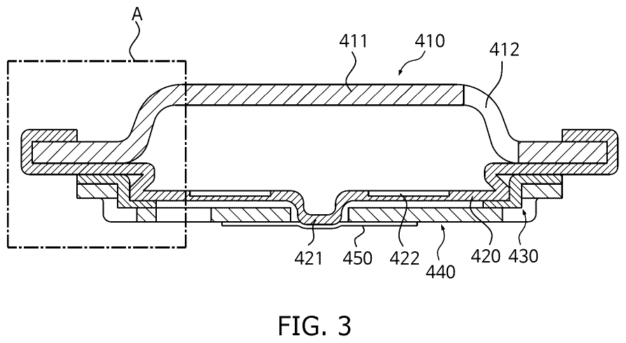

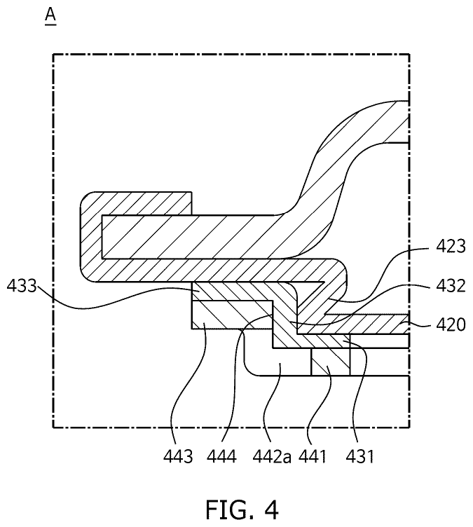

FIG. 2 is an exploded perspective view showing an example of the cap assembly according to some embodiments of the present disclosure, FIG. 3 is a cross-sectional view showing an example of the cap assembly according to some embodiments of the present disclosure, and FIG. 4 is an enlarged view showing an example of a region A of FIG. 3.

Referring to FIGS. 2 to 4, the cap assembly 400 according to some embodiments of the present disclosure may include an upper cap 410 connected to an external terminal (not shown), a vent plate 420 disposed below the upper cap 410, and a lower cap 440 disposed below the vent plate 420. A sub-plate 450 may be disposed below the lower cap 440 and electrically connect the vent plate 420 and the lower cap 440, and an insulator 430 may be disposed between the vent plate 420 and the lower cap 440.

The upper cap 410 may be disposed at the outermost side and form part of the outer appearance of the secondary battery. The upper cap 410 may be formed in a disk shape and may include a terminal portion 411 that protrudes outward from the central region, with the terminal portion 411 being electrically connectable to the external terminal. The upper cap 410 may be formed such that an exhaust port 412 extends along the circumference of the terminal portion 411 protruding outward. The exhaust port 412 form a passage for discharging gas generated inside the case to outside of the battery.

The vent plate 420 may be formed in a disk shape and may be disposed below the upper cap 410. The circumferential end of the vent plate 420 may be bent and joined to the upper cap 410 so as to surround the circumference of the upper cap 410.

The vent plate 420 may include a vent 421 protruding downward from a central region of the vent plate 420. The vent 421 may form a passage allows gas to be released from inside the case to outside of the battery by rupturing when a certain pressure is reached, which may also block electrical connection with the sub-plate 450.

The vent plate 420 may include a notch groove 422 that guides breakage of the vent 421. The notch groove 422 may be formed along the circumference of the vent 421 and may be formed to have a thin thickness, so that the notch groove 422 may be a part that is broken when the vent plate 420 is deformed due to an increase in the internal pressure of the case.

The vent plate 420 may include an S-shaped bend portion 423. The bend portion 423 may be configured to press the insulator 430 toward the lower cap 440 to thereby improve joining strength.

The lower cap 440 may be disposed below the vent plate 420 and may be electrically connected to the vent plate 420 by the sub-plate 450. In some embodiments, the lower cap 440 may include a lower plate 441 having a through hole 441a formed at a center of the lower cap 440 so that the vent 421 is inserted thereinto, a bridge portion 442 protruding axially (i.e., upward) from the outer circumferential surface of the lower plate 441, an upper plate 443 extending radially outward from the end of the bridge portion 442, and a pressing protrusion 444 protruding radially inward from the inner circumferential surface of the upper plate 443.

The insulator 430 may be disposed between the vent plate 420 and the lower cap 440 and may be configured to electrically insulate between the vent plate 420 and the lower cap 440 in a region. In some embodiments, the insulator 430 may include a ring plate 431 disposed above the lower plate 441, a connecting portion 432 protruding axially (i.e., upward) from the outer circumferential surface of the ring plate 431, and a flange portion 433 extending radially outward from the end of the connecting portion 432 and disposed above the upper plate 443.

Referring to FIG. 4, when the insulator 430 is disposed above the lower cap 440 and the vent plate 420 is disposed above the insulator 430, the S-shaped bend portion 423 of the vent plate 420 presses the insulator 430 toward the lower cap 440. As such, the outer circumferential surface of the connecting portion 432 of the insulator 430 may be pressed and joined to the pressing protrusion 444.

The lower cap 440 may further include an insertion hole 442a that extends radially along the circumference of the bridge portion 442. The pressing protrusion 444 may be disposed above the insertion hole 442a. With this configuration, when the insulator 430 is joined to the lower cap 440, a part of the insulator 430 pressed by the bend portion 423 of the vent plate 420 while being inserted into the insertion hole 442a.

The sub-plate 450 may be disposed below the lower cap 440. The lower cap 440 and the vent 421 penetrating the through hole 441a of the lower cap 440 may be joined such that the vent plate 420 and the lower cap 440 may be electrically connected to each other. The sub-plate 450 may be joined to the lower cap 440 and the vent 421 by welding.

In this configuration, a CID may be formed by the vent plate 420, the sub-plate 450, and the insulator 430. The CID may electrically isolate the vent plate 420 and the lower cap 440 by separating the vent 421 from the sub-plate 450 when the vent plate 420 deforms due to a increase in pressure inside of the battery case. When the vent plate 420 and the lower cap 440 are electrically separated, the electrode assembly and the cap plate may be electrically separated.

The insulator 430 may provide electrical insulation between the vent plate 420 and the lower cap 440 when the vent 421 is separated from the sub-plate 450. Therefore, in order to stably maintain the insulator 430 joined to the lower cap 440, it is necessary to increase the joining strength with the lower cap 440. The cap assembly 400 according to some embodiments of the present disclosure may improve such joining strength by surface-treating at least a portion of the surface of the lower cap 440 that comes into contact with the insulator 430 such that the surface coming into contact with the insulator 430 has a greater roughness. The surface-treated form and method are described in more detail below.

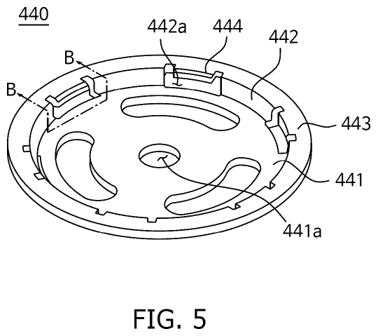

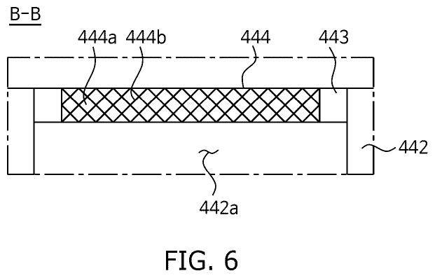

FIG. 5 is a perspective view showing an example of the lower cap in the cap assembly according to some embodiments of the present disclosure, and FIGS. 6 to 8 illustrate enlarged views showing examples of the surface-treated inner circumferential surface of the pressuring protrusion cut along a region B-B of FIG. 5.

Referring to FIG. 5, because the pressing protrusion 444 protruding radially inward from the lower cap 440 contacts the insulator, the inner circumferential surface of the pressing protrusion 444 may be surface-treated so that the inner circumferential surface of the pressing protrusion 444 has a greater roughness.

Referring to FIG. 6, in some embodiments the inner circumferential surface 444a of the pressing protrusion 444 may include knurled grooves 444b formed by knurling. Because the knurled grooves 444b are formed on the inner circumferential surface 444a of the pressing protrusion 444, the frictional force against the insulator increases, thereby improving the joining strength between the lower cap and the insulator. Further, in a case where the insulator is joined to the pressing protrusion 444 by heat fusion, the joining area may be increased by the knurled grooves 444b, thereby further improving the joining strength.

The knurled grooves 444b may be formed by pressing a knurling jig onto the inner circumferential surface 444a of the pressing protrusion 444. But the method of forming the knurled grooves 444b is not limited thereto, and the knurled grooves 444b may be formed through lathe processing, etc. In FIG. 6, the knurled grooves 444b is shown in a grid shape, but the present disclosure is not limited to such a shape. Rather, the knurled grooves 444b may be formed in various shapes, such as a horizontal straight line, a vertical straight line, or a diagonal shape.

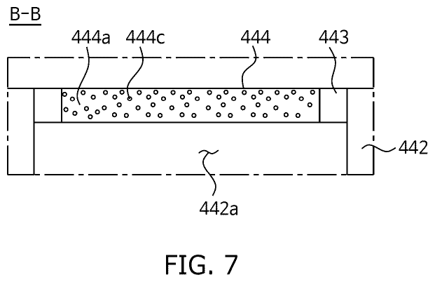

Referring to FIG. 7, in some embodiments the inner circumferential surface 444a of the pressing protrusion 444 may include a plurality of grooves 444c formed by blasting. Because the grooves 444c are formed on the inner circumferential Isurface 444a of the pressing protrusion 444, the frictional force against the insulator increases, thereby improving the joining strength between the lower cap and the insulator. Further, in a case where the insulator is joined to the pressing protrusion 444 by heat fusion, the joining area may be increased by the grooves 444c, thereby further improving the joining strength.

The grooves 444c may be formed on the inner circumferential surface 444a of the pressing protrusion 444 by micro blast etching using blast equipment. But the method of forming the grooves 444c is not limited thereto, and the grooves 444c may be formed by other processes, such as a chemical etching process.

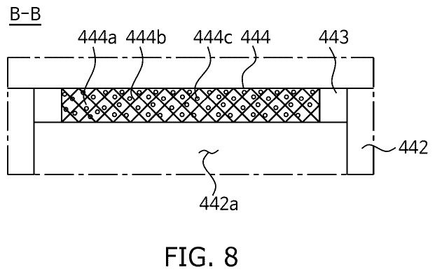

As illustrated in FIG. 8, the inner circumferential surface 444a of the pressing protrusion 444 may include both the knurled grooves 444b formed by knurling and the plurality of grooves 444c formed by blasting. That is, the knurling process may be performed to form the knurled grooves 444b on the inner circumferential surface 444a of the pressing protrusion 444, and then a blast process may be performed to additionally form the grooves 444c.

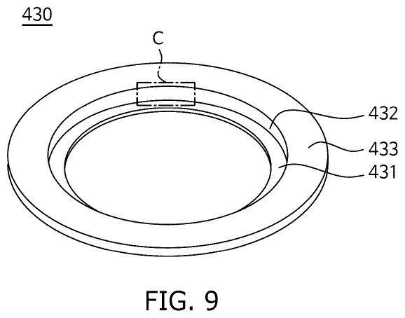

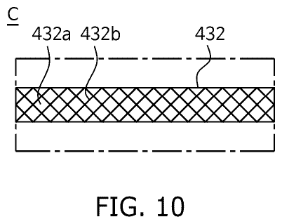

FIG. 9 is a perspective view showing an example of the insulator in the cap assembly according to some embodiments of the present disclosure, and FIGS. 10 to 12 illustrate enlarged views showing an example of the surface-treated outer circumferential surface of the insulator cut along a region C-C of FIG. 9.

Referring to FIG. 9, because the outer circumferential surface of the connecting portion 432 in the insulator 430 contacts the inner circumferential surface of the pressing protrusion, the outer circumferential surface of the connecting portion 432 may be surface-treated to have a greater roughness.

Referring to FIG. 10, in some embodiments the outer circumferential surface 432a of the connecting portion 432 may include knurled grooves 432b formed by knurling. As the knurled grooves 432b are formed on the outer circumferential surface 432a of the connecting portion 432, the frictional force with the pressing protrusion of the lower cap increases, thereby improving the joining strength.

The knurled grooves 432b may be formed by pressing a knurling jig against the outer circumferential surface 432a of the connecting portion 432. But the method of forming the knurled grooves 432b is not limited thereto, and the knurled grooves 432b may be formed through other processes, such as a lathe processing, or may be formed during a process of injection-molding the insulator. Although the knurled grooves 432b are illustrated in a grid shape in FIG. 10, the present disclosure is not limited with respect to the shape. Rather, the knurled grooves 432b may be formed in various shapes, such as a horizontal straight line, a vertical straight line, or a diagonal shape.

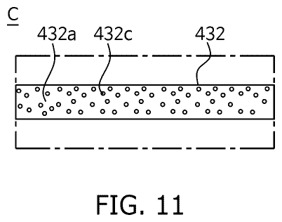

Referring to FIG. 11, in some embodiments the outer circumferential surface 432a of the connecting portion 432 may include a plurality of grooves 432c formed by blasting. Because the grooves 432c are formed on the outer circumferential surface 432a of the connecting portion 432, the frictional force with the pressing protrusion of the lower cap increases, thereby improving the joining strength.

The grooves 432c may be formed on the outer circumferential surface 432a of the connecting portion 432 by micro blast etching using blast equipment. But the method of forming the grooves 432c is not limited thereto, and the grooves 432c may be formed by other processes, such a chemical etching process.

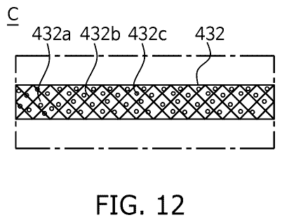

As illustrated in FIG. 12, the outer circumferential surface 432a of the connecting portion 432 may include both the knurled grooves 432b formed by knurling and the plurality of grooves 432c formed by blasting. For example, the knurling process may be performed to form the knurled grooves 432b on the outer circumferential surface 432a of the connecting portion 432, and then a blast process may be performed to additionally form the grooves 432c.

The cap assembly 400 according to some embodiments of the present disclosure may improve the joining strength with the insulator 430 by forming at least one of knurled grooves 444b and grooves 444b on the inner circumferential surface 444a of the pressing protrusion 444 that comes into contact with the insulator 430. Alternatively or additionally, at least one of the knurled grooves 432b and the grooves 432b may be formed on the outer circumferential surface 432a of the connecting portion 432 that contacts the pressing protrusion 444 in the insulator 430 to improve the joining strength with the pressing protrusion 444.

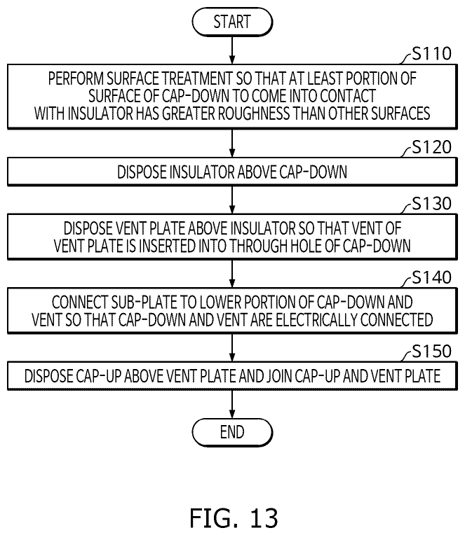

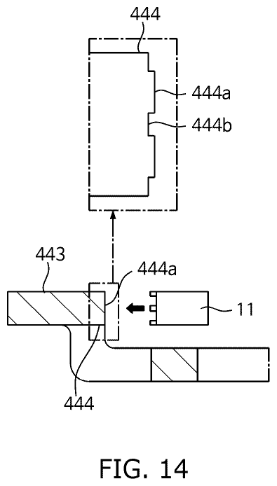

FIG. 13 is a flowchart showing an example of a method of manufacturing a cap assembly according to some embodiments of the present disclosure, and FIGS. 14 to 16 illustrate examples of surface treatment of an inner circumferential surface of a pressing protrusion.

Referring to FIGS. 2 and 13 to 16, a method of manufacturing the cap assembly 400 may include: performing surface treatment so that at least a portion of the surface of the lower cap 440 that contacts the insulator 430 has a greater roughness than other surfaces (S110); disposing the insulator 430 above the lower cap 440 (S120); disposing the vent plate 420 above the insulator 430 so that the vent 421 of the vent plate 420 is inserted into the through hole 441a of the lower cap 440 (S130); connecting the sub-plate 450 to the lower portion of the lower cap 440 and the vent 421 so that the lower cap 440 and the vent 421 are electrically connected (S140); and disposing the upper cap 410 above the vent plate 420 and bending the end of the vent plate 420 to the upper side of the upper cap 410 to join the upper cap 410 and the vent plate 420.

The surface-treating of at least a portion of the surface of the lower cap 440 (S110) may include surface-treating the pressing protrusion 444 so that the roughness of the inner circumferential surface of the pressing protrusion 444 of the lower cap 440 in contact with the insulator 430 is greater than the roughness of other surfaces. Referring to FIG. 14, in some embodiments, the surface-treating (S110) may include forming the knurled grooves 444b by knurling the inner circumferential surface 444a of the pressing protrusion 444. The knurled grooves 444b may be formed by pressing the knurling jig 11 against the inner circumferential surface 444a of the pressing protrusion 444. But the method of forming the knurled grooves 444b is not limited thereto, and the knurled grooves 444b may be formed through lathe processing, etc. The knurled grooves 444b may be formed in various shapes, such as a grid shape, a horizontal straight line, a vertical straight line, or a diagonal shape.

As the knurled grooves 444b are formed on the inner circumferential surface 444a of the pressing protrusion 444, the frictional force between the pressing protrusion 444 and the insulator increases, thereby improving the joining strength. Alternatively, in a case where the insulator is joined to the pressing protrusion 444 by heat fusion, the joining area may be increased by the knurled grooves 444b, thereby improving the joining strength.

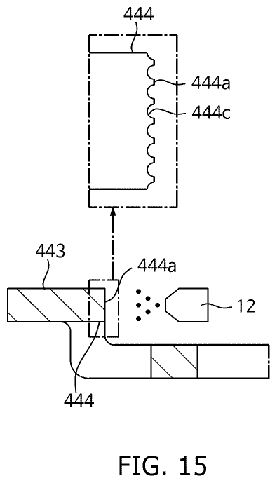

Referring to FIG. 15, in some embodiments the surface-treating (S110) may include forming the plurality of grooves 444c by blasting the inner circumferential surface 444a of the pressing protrusion 444. The grooves 444c may be formed on the inner circumferential surface 444a of the pressing protrusion 444 by micro blast etching, as described above But the method of forming the grooves 444c is not limited thereto, and the grooves 444c may be formed by other processes, such as a chemical etching process, etc.

As the grooves 444c are formed on the inner circumferential surface 444a of the pressing protrusion 444, the frictional force between the lower cap the insulator increases, thereby improving the joining strength between the two structures. When the insulator is joined to the pressing protrusion 444 by heat fusion, the joining area may be increased by the grooves 444c, thereby improving the joining strength.

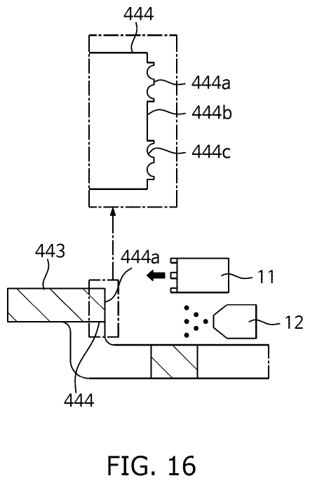

As illustrated in FIG. 16, the surface-treating (S110) may include forming knurled grooves 444b by knurling the inner circumferential surface 444a of the pressing protrusion 444, and additionally forming the plurality of grooves 444c by blasting the inner circumferential surface of the pressing protrusion 444 on which the knurled grooves 444b are formed. That is, the knurling process may be performed to form the knurled grooves 444b on the inner circumferential surface 444a of the pressing protrusion 444, and then a blast process may be performed to additionally form the grooves 444c.

The method for manufacturing the cap assembly 400 according to some embodiments of the present disclosure may further include surface-treating the outer circumferential surface of the insulator 430 so that at least a portion of the surface of the insulator 430 that contacts the lower cap 440 has a greater roughness than other surfaces. That is, the surface-treating of the outer circumferential surface of the insulator may be surface treated so that the outer circumferential surface of the insulator 430 that contacts the inner circumferential surface 444a of the pressing protrusion 444 of the lower cap 440 has a greater roughness than other surfaces.

In some embodiments, the surface-treating of the outer circumferential surface of the insulator 430 may include forming the knurled grooves 432b by knurling the outer circumferential surface of the insulator 430 that contacts the inner circumferential surface of the pressing protrusion 444 of the lower cap 440. The knurled grooves 432b may be formed by pressing the knurling jig 11 against the outer circumferential surface 432a of the connecting portion 432. But the method of forming the knurled grooves 432b is not limited thereto, and the knurled grooves 432b may be formed through lathe processing, etc., or may be formed when injection-molding the insulator 430. The knurled grooves 432b may be formed in various shapes, such as a grid shape, a horizontal straight line, a vertical straight line, or a diagonal shape. Accordingly, as the knurled grooves 432b are formed on the outer circumferential surface 432a of the connecting portion 432, the frictional force with the pressing protrusion 444 increases, thereby improving the joining strength.

In some embodiments, the surface-treating of the outer circumferential surface 432a of the insulator 430 may include forming the plurality of grooves 432c by blasting the outer circumferential surface of the insulator 430 that contacts the inner circumferential surface 444a of the pressing protrusion 444 of the lower cap 440. The grooves 432c may be formed on the outer circumferential surface 432a of the connecting portion 432 by micro blast etching using blast equipment 12. But the method of forming the grooves 432c is not limited thereto, and the grooves 432c may be formed by other processes such as chemical etching process, etc. Accordingly, as the knurled grooves 432c are formed on the outer circumferential surface 432a of the connecting portion 432, the frictional force between the connecting portion 432 and the pressing protrusion 444 increases, thereby improving the joining strength.

In some embodiments, the surface-treating of the outer circumferential surface 432a of the insulator 430 may include forming the knurled grooves 432b by knurling the outer circumferential surface 432a of the insulator 430 and additionally forming the plurality of grooves 432c by blasting the outer circumferential surface 432a on which the knurled grooves 432b are formed. The knurling process may be form the knurled grooves 432b on the outer circumferential surface 432a of the connecting portion 432, and then a blast process may be performed to additionally form the grooves 432c on the outwardly protruding surface.

Accordingly, the method of manufacturing the cap assembly according to embodiments of the present disclosure may improve the joining strength with the insulator 430 by forming at least one of the knurled grooves 444b and the grooves 444b on the inner circumferential surface 444a of the pressing protrusion 444 that contacts the insulator 430. In some embodiments, at least one of the knurled grooves 432b and the grooves 432b may be formed on the outer circumferential surface 432a of the connecting portion 432 that contacts the pressing protrusion 444 in the insulator 430 to improve the joining strength with the pressing protrusion 444.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

DESCRIPTION OF SOME REFERENCE SYMBOLS

| | |
|---|---|
| 100: secondary battery | 200: case |
| 300: electrode assembly | 400: cap assembly |
| 410: upper cap | 420: vent plate |
| 421: vent | 430: insulator |
| 431: ring plate | 432: connecting portion |
| 432a: outer circumferential | 432b: knurled groove |
| surface | |
| 432c: groove | 433: flange portion |
| 440: lower cap | 441: lower plate |
| 442: bridge portion | 443: upper plate |
| 444: pressing protrusion | 444a: inner circumferential |
| | surface |
| 444b: knurled groove | 444c: groove |
| 450: sub-plate | |

What is claimed is:

1. A cap assembly comprising:
an upper cap;
a vent plate disposed below the upper cap, the vent plate being deformable and comprising a vent protruding downward;
a lower cap disposed below the vent plate, with a through hole being formed in the lower cap, and with the vent being inserted into the through hole;
a sub-plate disposed below the lower cap and joined to the vent and the lower cap to electrically connect the vent plate and the lower cap; and
an insulator disposed between the vent plate and the lower cap,
wherein at least a portion of a surface of the lower cap in contact with the insulator is surface treated to have a greater roughness than another surface of the lower cap.

2. The cap assembly as claimed in claim 1, wherein the lower cap comprises:
a lower plate having the through hole formed at a center thereof;
a bridge portion protruding axially from an outer circumferential surface of the lower plate;
an upper plate extending radially outward from an end of the bridge portion; and
a pressing protrusion protruding radially inward with an inner circumferential surface of the pressing portion contacting the insulator and including the portion of the lower cap that is surface treated to have a greater roughness.

3. The cap assembly as claimed in claim 2, wherein the inner circumferential surface of the pressing protrusion comprises knurled grooves to provide the greater roughness.

4. The cap assembly as claimed in claim 2, wherein the inner circumferential surface of the pressing protrusion comprises a plurality of grooves to provide the greater roughness.

5. The cap assembly as claimed in claim 2, wherein the inner circumferential surface of the pressing protrusion comprises knurled grooves and a further plurality of grooves formed to provide the greater roughness.

6. The cap assembly as claimed in claim 2, wherein the insulator comprises:
a ring-shaped plate disposed above the lower plate;
a connecting portion configured to protrude axially from an outer circumferential surface of the ring plate, the connecting portion having a greater roughness than another surface of the insulator, and the connecting portion contacting the inner circumferential surface of the pressing protrusion; and
a flange portion extending radially outward from an end of the connecting portion and disposed above the upper plate.

7. The cap assembly as claimed in claim 6, wherein the outer circumferential surface of the connecting portion in contact comprises knurled grooves to provide the greater roughness.

8. The cap assembly as claimed in claim 6, wherein the outer circumferential surface of the connecting portion comprises a plurality of grooves to provide the greater roughness.

9. The cap assembly as claimed in claim 6, wherein the outer circumferential surface of the connecting portion comprises a plurality of knurled grooves and a further plurality of grooves to provide the greater roughness.

10. A secondary battery comprising:
a case having an opening formed therein;
an electrode assembly accommodated in the case, the electrode assembly comprising a first electrode, a separator, and a second electrode; and
a cap assembly sealing the opening of the case,
wherein the cap assembly comprises:
an upper cap;
a vent plate disposed below the upper cap, the vent plate being deformable in response to pressure change inside the case, the vent plate comprising a vent protruding downward;
a lower cap disposed below the vent plate, with a through hole being formed in the lower cap, and with the vent being inserted into the through hole;
a sub-plate disposed below the lower cap and joined to the vent and the lower cap to electrically connect the vent plate and the lower cap; and
an insulator disposed between the vent plate and the lower cap,
wherein at least a portion of a surface of the lower cap in contact with the insulator is surface treated to have a greater roughness than another surface of the lower cap.

11. A method of manufacturing a cap assembly, the method comprising:
surface treating at least a portion of a surface of a lower cap that is configured to contact with an insulator such that the portion of the surface has a greater roughness than another surface of the lower cap;
disposing the insulator above the lower cap;
disposing a vent plate above the insulator so that a vent of a vent plate is inserted into a through hole formed in the lower cap;
connecting a sub-plate to a lower portion of the lower cap and the vent so that the lower cap and the vent are electrically connected by the sub-plate; and
disposing a upper cap above the vent plate and joining the upper cap and the vent plate.

12. The method as claimed in claim 11, wherein the lower cap comprises:
a lower plate having the through hole formed at a center thereof;
a bridge portion protruding axially from an outer circumferential surface of the lower plate;
an upper plate extending radially outward from an end of the bridge portion; and
a pressing protrusion protruding radially inwardly from the upper plate,
wherein the surface treatment comprises surface treating the pressing protrusion so that roughness of an inner circumferential surface of the pressing protrusions greater than roughness of another surface of the lower cap.

13. The method as claimed in claim 12, wherein the surface treatment comprises forming knurled grooves by knurling the inner circumferential surface of the pressing protrusion.

14. The method as claimed in claim 12, wherein the surface treatment comprises forming a plurality of grooves by blasting the inner circumferential surface of the pressing protrusion.

15. The method as claimed in claim 12, wherein the surface treatment comprises:
forming knurled grooves by knurling the inner circumferential surface of the pressing protrusion; and
additionally forming a plurality of grooves by blasting the inner circumferential surface of the pressing protrusion on which the knurled grooves are formed.

16. The method as claimed in claim 11, further comprising surface treating an outer circumferential surface of the insulator that is configured to contact the lower cap so that at least a portion of the surface of the insulator has a greater roughness than another surface of the insulator.

17. The method as claimed in claim 16, wherein the outer circumferential surface of the insulator is configured to contact the inner circumferential surface of the pressing protrusion of the lower cap.

18. The method as claimed in claim 16, wherein the surface treating of the outer circumferential surface of the insulator comprises forming knurled grooves by knurling the outer circumferential surface of the insulator.

19. The method as claimed in claim 16, wherein the surface treating of the outer circumferential surface of the insulator comprises forming a plurality of grooves by blasting the outer circumferential surface of the insulator.

20. The method as claimed in claim 16, wherein the surface treating of the outer circumferential surface of the insulator comprises:
forming knurled grooves by knurling the outer circumferential surface of the insulator; and
additionally forming a plurality of grooves by blasting the outer circumferential surface on which the knurled grooves are formed.
